(19) United States
(12) Patent Application Publication
(10) Pub. No.: US 2003/0130135 A1
(43) Pub. Date: Jul. 10, 2003

(54) Emulsifier for oil-based drilling fluids

(75) Inventors: Peter Wangqi Hou, Dublin, OH (US); Yun-Peng Zhu, Edgewater, NJ (US); David G. Feuerbacher, Westerville, OH (US)

Correspondence Address: Michael P. Dilworth, CROMPTON CORPORATION, Benson Road, Middlebury, CT, 06749, US

(73) Assignee: CROMPTON CORPORATION

(21) Appl. No.: 09/987,047

(22) Filed: Nov. 13, 2001

(51) Int. Cl. C09K 7/00

(52) U.S. Cl. 507/200

(57) ABSTRACT

A composition comprising a water-in-oil emulsion fluid for use in the drilling, completion or workover of a subterranean well is disclosed, wherein the emulsion fluid comprises:

A) a base comprising at least one liquid hydrocarbon;

B) an aqueous phase; and

C) an emulsifier comprising at least one amide prepared by reacting at least one fatty amine with at least one polycarboxylic acid.

### BACKGROUND OF THE INVENTION

1. Field of the Invention

The present invention relates to emulsifier compositions and to the production of stable water-in-oil emulsions containing such emulsifier compositions. The emulsifiers of the present invention and the emulsions prepared therewith are especially suitable for use in the formation of water-in-oil drilling fluids, known as invert muds, of drilling wells to tap subterranean deposits of fluids, such as oil and/or gas.

2. Description of Related Art

It is often desired to prepare emulsions of water and oil. Emulsions of water in various oleaginous media wherein the oleaginous material is the continuous phase and water or aqueous material is the dispersed phase have been employed for numerous applications, such as oil well drilling muds, cutting oils, hydraulic fluids, lubricants, cosmetics, agricultural emulsions, and the like, where the lubricating, corrosion protection, or cosmetic characteristics of the oleaginous material is desired, and water or aqueous material serves to bring about fire resistance and the like. Such emulsions are commonly prepared prior to use so as to insure proper formulation, or they may be formed in situ where, for example, environmental moisture is emulsified, thereby reducing corrosion problems or preventing the water from being absorbed by the surroundings.

It is generally agreed among those skilled in the art that a rotary system is the most acceptable form of drilling a subterranean well. This system depends upon the rotation of a column of drill pipe to the bottom of which is attached a multi-pronged drilling bit. The bit cuts into the earth, causing the cuttings to accumulate as drilling continues. As a result, a drilling fluid must be used to carry these cuttings to the surface for removal, thus allowing the bit to continue functioning, and the bottom hole to be kept clean and free of cuttings at all times. Drilling systems other than the rotary system are sometimes employed in drilling operations; nevertheless, these systems still require a drilling fluid to remove borehole cuttings, and to otherwise perform functions related to drilling fluids. In many instances, what is generally referred to as a “drilling fluid” actually may be utilized, with either no modification, or only minor modification, as a fluid for use in conjunction with completing or working over a subterranean well. In this regard, utilization of the phrase “drilling fluid” herein contemplates the utilization of such fluid in such completion and workover operations in subterranean wells, as well as in drilling operations.

Although aqueous-based drilling fluids which utilize clear water, brine, saturated brine, or sea water as the primary liquid base, may be found to be dominant within some facets of the drilling industry, there is a considerable need for drilling fluids wherein a hydrocarbon liquid forms the major liquid constituent, particularly in instances in which the drilling fluid is utilized in the higher temperature wells which are drilled to the more substantial depths.

Hydrocarbon-based drilling fluids normally are defined as invert emulsion, or water-in-oil emulsion, drilling fluids. These emulsions provide droplets of water that typically are dispersed in a continuous phase of oil. The oil comprises a hydrocarbon, such as mineral oil, diesel oil, crude oil, kerosene, a poly(alpha-olefin), or the like. The amount of oil used is normally within the range of about 60 to about 95 parts by volume, and preferably within the range of about 70 to about 90 parts by volume, on the basis of 100 parts equaling the liquid phase of the drilling fluid. At the higher level of the range, a drilling fluid with a comparatively lower viscosity will be produced, while drilling fluids having a lesser amount of oil will produce a comparatively higher viscosity fluid. The concentration of the selected hydrocarbon depends upon the particular application for which the water-in-oil drilling fluid is to be used.

The dispersed liquid phase of the drilling fluid is normally referred to as the “water phase” and may consist of fresh water, salt water, sea water, or saturated brine. Normally, the presence of typical amounts of sodium chloride, calcium chloride, calcium carbonate, or calcium sulfate salts will have some, but no significant, effect on the stability of the emulsion produced. The water concentration should be in the range from between about 5 to about 40 parts by volume, and, preferably, will be within the range of about 10 to about 30 parts by volume, on the basis of 100 parts equaling the liquid phase of the drilling fluid composition. Again, the exact concentration depends upon the particular application for which the invert emulsion drilling fluid is to be used.

The liquid hydrocarbons normally serve as a continuous liquid vehicle to be converted into a drilling fluid having desirable properties for the desired applications by adding various materials to thicken the fluid so that it will support cuttings and provide a low fluid loss when the fluid is subjected to filtration against a permeable formation and in addition to increase the density of the fluid. As is known, oil-based drilling fluids are used for well-drilling associated with high temperature, high pressure and/or other difficult formations. In environmentally sensitive areas, synthetic or mineral base oils may be used. In such use, it is desirable to employ an oil base fluid having low filtration. It is also advantageous to use an oily fluid to minimize corrosion and to provide low fluid loss characteristics over lengthy time periods wherein the packing fluid remains in place. These operations involving drilling, fracturing, and packing are well-working operations; and the oil base well-drilling fluids, well-fracturing fluids, and well-packing fluids are all termed “oil base well-working fluids,” as used in the following specification and claims.

U.S. Pat. No. 3,041,275 discloses a composition suitable for use as a drilling fluid at high temperatures consisting essentially of from about 20 to about 70 parts by volume of a mineral oil, from about 80 to about 30 parts by volume of water, at least about two pounds per barrel of said composition of an amide of a gamma hydroxy carboxylic acid having from four to six carbon atoms and an aliphatic amine having an unsaturated hydrocarbon radical containing at least about 12 carbon atoms, at least about one pound per barrel of said composition of a soap selected from the group consisting of aluminum oleate and alkali metal soaps of organic acids containing from about 12 to about 20 carbon atoms, and said soap being in an oil-dispersible form, from 0 to about 600 pounds per barrel of said composition of a finely divided solid insoluble in said oil and said water, from 0 to about 20 pounds per barrel of said composition of a solid natural asphaltic mineral in finely divided form, and from 0 percent salt to a sufficient amount of salt to saturate the aqueous phase of said composition.

U.S. Pat. No. 3,169,113 discloses an emusifier for a water-in-oil fracturing fluid, wherein said emulsifier contains one or both of (a) a nine to 18 carbon monocarboxylic acid fatty acid salt of a partial amide of a polyalkylene polyamine with two to six carbon alkylene groups and three to five amino nitrogens in which at least two amino groups are amidified with nine to 18 carbon monocarboxylic fatty acids and wherein there is at least one nonamidified amino group forming a salt with the acid and (b) a polyamide of an alkylene polyamine with two to six carbon alkylene groups and two to five amino nitrogens and a nine to 18 monocarboxylic fatty acid.

U.S. Pat. No. 3,590,005 discloses emulsifier compositions comprising admixtures of (a) between about 10 percent and 90 percent by weight of an oxidized hydrocarbon wax-amine condesation product and (b) between about 90 percent and 10 percent of a metal salt of an oxidized hydrocarbon wax, said emulsifier compositions being particularly effective for preparing water-in-oil emulsions that are stable in the presence of electrolytes and at temperatures as high as about 260° C.

U.S. Pat. No. 4,575,428 discloses a surfactant for use in invert emulsion drilling fluids, the invert emulsion drilling fluid produced therefrom, and a method of drilling, completing and working over a subterranean well utilizing said drilling fluid. The drilling fluid comprises an emulsion formed by producing a diamide having from between about 20 mole percent and about 35 mole percent of a polyamine, and from between about 30 mole percent and about 70 mole percent of a fatty acid having from between about six to about 20 carbon atoms therein, the diamide thereafter being further reacted with from between about 15 mole percent and about 35 mole percent of a tricarboxylic acid. The total amine value of said oligamide being from between about 10 to about 30, and the acid value of said oligamide being from between about 26 to about 46. When the surfactant is diluted to about 70 w/w percent concentration with a suitable solvent, the ES₃, as defined in the patent, of said emulsion drilling fluid will exceed about 400 volts, the ES₅ will be greater than the ES₄, and the ES₅ will be greater than about 1,000 volts. Alternatively, the electrical stability of the emulsion drilling fluid, when using the API Electrical Stability Test, should be at least about 1,000 volts.

U.S. Pat. No. 4,658,036 discloses a process for the preparation of invert emulsifiers useful for oil-base drilling muds. The emulsifiers are prepared by reacting at least one tall oil fatty acid with acrylic acid, maleic anhydride, or fumaric acid. The product of this reaction is substantially reacted with diethylene triamine, and at least one tall oil fatty acid to give the invert emulsifier.

U.S. Pat. No. 4,735,732 discloses a filtration control additive for use in invert emulsion drilling fluids; the method of preparing such additives; the invert emulsion drilling fluid produced therefrom; and a method of drilling, completing, and working over a subterranean well, utilizing such drilling fluid containing the filtration control additive which is utilized in a water-in-oil, emulsion-type subterranean drilling fluid. The additive comprises the pyrolyzed product obtained by intermixing and heating a finely divided humic acid-containing material and a primary amine having an alkyl radical of 10 to 20 carbon atoms or a primary amine having one alkyl-substituted phenyl radical, the alkyl radical having 10 to 20 carbon atoms. The amine may also be a secondary amine having at least one alkyl radical of eight to 20 carbon atoms.

U.S. Pat. No. 4,876,017 discloses the use of a synthetic hydrocarbon compound, such as a polyalphalolefin, which may be combined with emulsifiers and thinners (functional additives) at a ratio of approximately 9:1, to serve as a downhole lubricant that is nontoxic and presents no destruction to marine life. In addition, the polyalphalolefin may be used at a higher ratio of the polyalphalolefin to functional additives to function as a spotting fluid for the removal of lodged tools downhole, exhibiting the same nontoxic qualities as when it is used as a lubricant.

U.S. Pat. No. 5,045,219 discloses a composition and application thereof relating to a synthetic hydrocarbon compound, a polyalphaolefin liquid, blended in various concentrations with chemical oil and water emulsifiers, thinners and oil and water surface tension reducers, the concentration of polyalphaolefin liquid to that of the remaining portion of the blend being no less than 5 percent; blending the polyalphaolefin liquid and the emulsifiers in a blending tank containing water base drilling mud; circulating the blend of polyalphaolefin liquid and emulsifier with the water base drilling mud down hole, so that the blend of polyalphaolefin liquid emulsifier and water base drilling mud lubricates the drill string or reduces the differential pressure between the wall of the borehole and the drill string so that the drill string is free to rotate and drilling may be undertaken with less drag or torque. In another application, the polyalphaolefin blended with the emulsifier serves as a spotting fluid in order to unstick drill pipe that has become stuck.

U.S. Pat. No. 6,211,139 discloses certain amine and quaternary ammonium compounds and formulations thereof that are said to be useful as, for instance, fabric softeners, paper debonders, hair conditioners, skin conditioners, paper deinking and ink flotation agents, asphalt emulsion agents, corrosion inhibitor agents, ore flotation agents, pesticide emulsion agents, car drying aid sprays, drilling fluid additives, and the like.

The disclosures of the foregoing are incorporated herein by reference in their entirety.

### SUMMARY OF THE INVENTION

According to the present invention, fatty amines are reacted with polycarboxylic acids to form mixtures of mono-, di-, and tri-amides, which are excellent emulsifiers for oil-based drilling fluids, specially for synthetic oil-based fluids. Drilling fluids thus made have very high electrical stability (over 1,000 volts).

Oil-based drilling fluids that employ commercially available emulsifiers generally have low electrical stability and it is difficult to adjust the rheology thereof without affecting the electrical stability. The emulsifiers of the present invention make possible oil-based drilling fluids having extremely high electrical stabilities, which are indicative of invert emulsion stability.

The emulsifiers of the present invention are reaction products of fatty amines with polycarboxylic acids. The fatty amines can be primary amines, secondary amines, or tertiary amines. The polycarboxylic acid can be di- or tri-carboxylic acids. For example, primary tallow amine can be reacted with citric acid to form the emulsifier di-tallow citric amide. The emulsifier is then combined with a base oil to form the drilling fluid. The base oil can, for example, be a diesel, synthetic, or mineral oil. Preferably, the oil-based drilling-fluid is made of a polyalphaolefin (PAO) or paraffin as base oil and di-tallow citric amide as emulsifier, which provides a product having electrical stability of over 1,000 volts and adjustable rheology.

More particularly, the present invention is directed to a composition comprising a water-in-oil emulsion fluid for use in the drilling, completion or workover of a subterranean well, said emulsion fluid comprising:

A) a base comprising at least one liquid hydrocarbon;

B) an aqueous phase; and

C) an emulsifier comprising at least one amide prepared by reacting at least one fatty amine with at least one polycarboxylic acid.

### DESCRIPTION OF THE PREFERRED EMBODIMENTS

A fatty amine is used in the process of the invention. The term “fatty amine,” as employed herein, is an amine that contains one or more long-chain hydrocarbyl groups, which can be further substituted with other functional groups such as ether or hydroxyl groups.

The amines employed in the practice of the present invention are of the structural formula

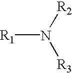

wherein R₁, R₂, and R₃ are selected from the group consisting of hydrogen, hydrocarbyl groups, and hydrocarbyl groups substituted with functional groups, provided that at least one of R₁, R₂, or R₃ is a C₈ or greater hydrocarbyl group, and is preferably a C₈-C₃₀ hydrocarbyl group. Suitable fatty amines include primary, secondary, tertiary, and ethoxylated or propoxylated amines. Examples include oleylamine, 1-dodecylamine, di-n-octadecylamine, tri(isodecyl)amine, dimethyl-n-decylamine, bis(2-hydroxyethyl)dodecylamine, tallow amine, bis(2-hydroxyethyl)tallowamine, and bis(2-hydroxypropyl)dodecylamine and the like.

While the amidification can be carried out with an appropriate quantity of one such amine, it is preferred for reasons of economy, product performance, and convenience to employ mixtures of amines, each corresponding to the structural formula R₁NH₂ For example, mixtures of fatty amines derived from various animal and vegetable origins are conveniently commercially available. One example of such material is tallow amines which, as is generally known in this field, is a mixture of fatty amines predominantly composed of fatty amines containing 14, 16, and 18 carbon atoms, and 0, 1, and 2 degrees of unsaturation. Other sources include coconut fatty amines and canola fatty amines, although any suitable fatty amine can be used. Amidification can be carried out under conventional conditions, well-known to the chemist in this field, allowing for the withdrawal of byproducts. The number of moles of fatty amine is selected to provide the desired average degree of amidification in the mixture of products formed upon amidification.

The polycarboxylic acids that can be reacted with the above-described amines to form the amides of the present invention include, for example, lactic acid, glycollic acid and ether derivatives thereof as disclosed in Belgian Pat. Nos. 821,368, 821,369 and 821,370; succinic acid, malonic acid, (ethylenedioxy) diacetic acid, maleic acid, diglycollic acid, tartaric acid, tartronic acid and fumaric acid; citric acid, aconitic acid, citraconic acid, carboxymethyloxysuccinic acid, lactoxysuccinic acid, and 2-oxy-1,1,3-propane tricarboxylic acid; oxydisuccinic acid, 1,1,2,2-ethane tetracarboxylic acid, 1,1,3,3-propane tetracarboxylic acid and 1,1,2,3-propane tetracarboxylic acid; cyclopentane-cis, cis, cis-tetracarboxylic acid, cyclopentadienide pentacarboxylic acid, 2,3,4,5-tetrahydrofuran-cis, cis, cis-tetracarboxylic acid, 2,5-tetrahydrofuran-cis-dicarboxylic acid, 1,2,3,4,5,6-hexane-hexacarboxylic acid, mellitic acid, pyromellitic acid, phthalic acid and derivatives thereof, such as those disclosed in British Pat. No. 1,425,343, and the like. Dicarboxylic and tricarboxylic acids are preferred, tricarboxylic acids more preferred, and citric acid most preferred.

Normally, in the amidification, at least one carboxylic acid function will remain unreacted with the amine. For example, particularly preferred amides for use in the practice of the present invention include those of the structures:

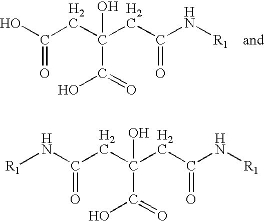

wherein R₁ is as described above.

The amine, e.g., tallow amine, can be reacted with the polycarboxylic acid, e.g., citric acid, to form the amides of the invention in the following ways.

### Sample A

Preparation of a diamide from tallow amine and citric acid: a 500 mL flask was charged with Adogen-170 (150.0 gm), (Adogen 170 is tallow amine, a product made by Goldschmidt) followed by heating the flask to a temperature set at 100° C. After the temperature reaches 100° C., citric acid (55 gm) was carefully added so as to control the reaction temperature below 130° C. After completion of addition of citric acid, the reaction was continued at ca. 160° C. for about another 1.5 hours so as to complete the reaction. The reaction was monitored by use of total amine value and acid value. IR, NMR, and GPC identified the structure of the prepared titled compound.

### Sample B

Preparation of monoamide from tallow amine and citric acid: a 500 mL flask was charged with citric acid (57.64 gm) and MeOH (100 gm). The mixture was heated to 70° C. and the citric acid was dissolved to form a solution. The mixture was stirred for 30 minutes at 70° C., and Adogen-170 (77.72 gm) was carefully added so as to control the reaction temperature below 80° C. A trap was set to collect the distillates. After completion of addition of Adogen 170, the reaction was continued at 90° C. for another one hour and distillate (70 gm) was collected. The temperature was set at 135° C. and the reaction was continued for another one hour, while a very small stream of N₂ gas was introduced. The reaction was monitored by use of total amine value and acid value. IR, NMR, and GPC identified the structure of the prepared titled compound.

### Sample C

Preparation of triamide from tallow amine and citric acid: a 500 mL flask was charged with Adogen-170 (158.6 gm), followed by heating the flask to a temperature set set at 90° C. After the temperature reached 90° C., citric acid (38.6 gm) was carefully added so as to control the reaction temperature below 130° C. After completion of addition of citric acid, the reaction was continued at ca. 155-160° C. for about another 2.5 hours so as to complete the reaction. The reaction was monitored by use of total amine value and acid value. IR, NMR, and GPC identified the structure of the prepared titled compound.

The equipment utilized in determining emulsion stability consists of a reliable circuit using a source of DC current in portable units (which provides a ramped, sinusoidal electrical signal) connected to a pair of parallel flat-plated electrodes. The voltage imposed across the electrodes can be increased rapidly until a predetermined amount of current flows. The measure of emulsion breakdown is indicated by current flow. Relative stability is indicated as a voltage at breakdown point. In the procedure utilizing such equipment, the electrodes are inserted into the drilling fluid sample to be tested. The voltage range multiplier that is applicable is selected. The voltage across the electrodes is increased until the instrument indicates emulsion breakdown. The voltage reading is recorded as an electrical stability number at a given temperature. Typically, this reading should be above about 1,000 volts for a laboratory-prepared emulsion mud. This test is referred to hereafter as the “API Electrical Stability Test.”

Still another criterion for determining the preparation of a satisfactory emulsion for utilization in the present invention is a high temperature and high pressure filtration test and the emulsion stability of a prepared mud utilizing the surfactant of the present invention. On a commercial and field basis, the filtration and emulsion stability tests of Sections 3 and 8, respectively, of the Recommended Practice Standard Procedure for Field Testing Oil-Based Drilling Fluids” (RP-138B, second edition, Dec. 1, 1991), prepared by the American Petroleum Institute, can be easily utilized. The instrument utilized in the filtration test consists essentially of a controlled pressure source, a cell designed to withstand a working pressure of at least 1,000 PSI, a system for heating the cell, a suitable frame to hold the cell and heating system and a pressurized collection cell designed to withstand a working back pressure of at least 500 PSI to avoid flashing or evaporation of the filtrate at high temperatures.

Water-in-oil emulsions prepared in accordance with the present invention, utilizing the above described emulsifier compositions, comprise from about one to about 97 parts by weight of water or aqueous electrolyte solution as the dispersed phase, from about 99 to about three parts by weight of oleaginous material as the continuous phase, and at least about 1 percent and preferably between about 2 percent and 6 percent by weight, based on the weight of the aqueous and oleaginous phases of the emulsion, of the emulsifier composition of the present invention. It is particularly desirable that the emulsions contain from about 30 to about 70 parts by weight of water or aqueous electrolyte solution as the dispersed phase, from about 70 to about 30 parts by weight of oleaginous material as the continuous phase, and about 3 percent to 4 percent by weight, based on the weight of the aqueous and oleaginous phases of the emulsion, of the emulsifier composition of the present invention.

The emulsifier is evaluated in synthetic oil-based drilling fluid systems. The following is the preparation procedure of oil-based drilling fluids. Base fluid (either normal paraffin or polyalpha olefin) (173 mL) is measured into a 350 mL conical container. Fresh water (77 mL) is then added to the base fluid. A Hamilton-Beach mixer at medium speed is used as the blending equipment. Two grams of organophilic clay is added while mixing. After ten minutes, two grams of lime, seven grams of organophilic lignite, and eight grams or a specified weight of emulsifier are mixed into the blend for five minutes. Barite (327 grams) is added next and mixing is carried out for another five minutes. Finally, 27 grams of calcium chloride is added and blended for ten minutes. The prepared oil-based mud is then evaluated for rheology properties and electrical stability.

The above mud is then aged in a roller oven. The roller oven temperature is set at 150° F. (about 66° C.). Mud is being sealed in aging cells. After the oven reaches the designed temperature, the cells are placed in the oven for 16 hours.

The shear stability is run with a Multi-mixer. At least three samples are tested at a time. Base oil (160 mL) is added to a 350 mL conical container, then emulsifier is added. The initial concentration of emulsifier will be near 1 to 2 grams. The lowest amount of emulsifier is where the mud water-wets within one hour shear time. A quantity of 43 grams of calcium chloride solution (33% by wt.) is further added to the container and mixing is carried out for five minutes. Three grams of organophilic clay is then added to the blend followed by 15 minutes of mixing. Four hundred grams of barite is added last, followed by 30 minutes of mixing. The sample temperature and electric stability are measured and recorded. This is followed by mixing for another 30 minutes, whereupon the sample temperature and electric stability are again measured and recorded.

In the practice of the present invention, the above described emulsifiers are combined with a base oil to form the drilling fluid. Any of the base oils known in the art can be used for this purpose, the most common being vegetable oil, mineral oil, and diesel oil.

Crude and refined oils were used as early as the 1920s to drill troublesome formations, free stuck pipe, and as completion and packer fluids. Later developments saw the use of No. 2 diesel oil as a common additive to mud systems. More recent environmental concerns over the toxicity of diesel oils required a base fluid change to less toxic refined mineral oils. Current industry requirements in offshore drilling are to have nontoxic fluids that can pass discharge guidelines as specified by the Environmental Protection Agency.

Overall, these types of oils suffer from many drawbacks, the most pertinent being that the oil is highly toxic to marine life. For example, should the oil in an offshore drilling operation spill over into the water, it has been determined that mineral oil or vegetable oil owing to its heavy oily nature will, in effect, coat the gills of marine animals and destroy valuable marine life. In fact, the Environmental Protection Agency has taken steps to assure that these types of oil are used under very stringent regulations during offshore drilling and, for the most part, in all likelihood should not be used at all. Vegetable oils have been used as substitutes offering a nontoxic alternative but have not proven to be effective performers in this application.

It is accordingly preferred in the practice of the present invention that a synthetic hydrocarbon, more particularly a polyalphalolefin, be employed. These synthetic hydrocarbons are highly effective in drilling fluid lubricants and spotting fluids and have a low order of toxicity.

Polyalphaolefin synthetic hydrocarbons are chemically pure, highly defined liquid polymers quite unlike the complex mixtures of hydrocarbons that comprise mineral oils. They are formed by the oligomerization of normal alpha olefins, which can be derived from ethylene. By altering the degree of oligomerization, the properties of the fluid can be modified. The olefin oligomers are subsequently hydrogenated to lend stability to the molecule. Since the polyalphaolefin contains only carbon and hydrogen and conforms substantially to one kind of structure, the properties of the fluid are uniform and predictable. The preferred polyalphaolefins used in this invention range from a 2 centistoke to a 10 centistoke viscosity range.

The polyalphalolefins are especially useful in offshore applications or environmentally sensitive areas, since they are completely nontoxic to marine life, and therefore offer no threat in offshore application should a spill occur.

Organophilic clay, quaternary amine treated clay, is added to the water-in-oil mud to adjust mud rheology properties and, to some extent, filtration control. Organophilic lignite is also needed in the mud system to control filtration. Barite or other unhydratable, non-active solid is added to increase mud density.

Various features and aspects of the present invention are illustrated further in the examples that follow. While these examples are presented to show one skilled in the art how to operate within the scope of the invention, they are not intended in any way to serve as a limitation upon the scope of the invention.

### EXAMPLES

The following tables show the test data that were obtained following the Standard Procedure for Field Testing Oil-based Drilling Fluids. (API Recommended Practice 13B-2). Fan 35A, HTHP filtration test cell, and electric stability tester are the apparatus involved to 5 acquire these data. Aging is done in a roller oven at 150° F. for 16 hours.

Two synthetic base oils were evaluated. One is normal paraffin, the other is a polyalpha olefin. The prepared mud is a 14 lb/gal, 70/30 oil/water ratio, 25% calcium chloride water-phase salinity oil mud. Experimental emulsifiers A, B, and C were synthesized and compared with Witcomul 3241. Emulsifier Samples A, B, and C were made by the above-described methods.

Witcomul 3241 (Crompton Corporation) is a widely used, commercially available emulsifier product in the market. It is used as a benchmark. In the following tables, the normal paraffin was a mixture of C₁₃ to C₁₅ chain length paraffin, the polyalpha olefin was an isomerized C₁₆/C₁₈ alpha olefins, the organophilic lignite was Duraton HT, and the organophilic clay was Gelton HT.

Mud Test - Normal Paraffin

| | | | | | |
|---|---|---|---|---|---|
| Base oil normal paraffin, mL | 173 | 173 | 173 | 173 | 173 |
| Fresh water, mL | 77 | 77 | 77 | 77 | 77 |
| Organophilic clay, grams | 2 | 2 | 2 | 2 | 2 |
| Emulsifier, Sample A, grams | 8 | 6 | 5 | 4 | 3 |
| Lime, grams | 2 | 2 | 2 | 2 | 2 |
| Organophilic lignite, grams | 7 | 7 | 7 | 7 | 7 |
| Barite, grams | 327 | 327 | 327 | 327 | 327 |
| Calcium chloride, grams | 27 | 27 | 27 | 27 | 27 |
| Test temperature, ° F. | 120 | 120 | 120 | 120 | 120 |
| 600 rpm | 71 | 80 | 79 | 75 | 70 |
| 300 rpm | 44 | 52 | 50 | 50 | 46 |
| 200 rpm | 33 | 41 | 40 | 40 | 37 |
| 100 rpm | 22 | 28 | 29 | 29 | 27 |
| 5 rpm | 8 | 9 | 10 | 12 | 13 |
| 3 rpm | 6 | 7 | 9 | 10 | 11 |
| Electrical stability, V | 1037 | 740 | 791 | 834 | 877 |
| Plastic viscosity, cp | 27 | 28 | 29 | 25 | 24 |
| Yield point, lb/100 sq. feet | 17 | 24 | 21 | 25 | 22 |
| 10 sec/10 min. gel, lb/100 sq. feet | 7/8 | 8/10 | 10/12 | 10/15 | 11/19 |
| After rolling 16 hours at 150° F. | | | | | |
| Test temperature, ° F. | 120 | 120 | 120 | 120 | 120 |
| 600 rpm | 62 | 96 | 79 | 68 | 69 |
| 300 rpm | 37 | 60 | 50 | 43 | 41 |
| 200 rpm | 28 | 46 | 39 | 33 | 31 |
| 100 rpm | 17 | 30 | 26 | 22 | 21 |
| 6 rpm | 5 | 9 | 9 | 9 | 9 |
| 3 rpm | 4 | 7 | 8 | 8 | 8 |
| Electrical stability, V | 1155 | 1476 | 1267 | 1030 | 715 |
| Plastic viscosity, cp | 25 | 36 | 29 | 25 | 28 |
| Yield point, lb/100 sq. feet | 12 | 24 | 21 | 18 | 13 |
| 10 sec/l0 min gel, lb/100 sq. feet | 5/10 | 9/12 | 10/13 | 10/13 | 9/13 |
| HTHP filtrate temperature, 300° F. | | | | | |
| filtrate, total volume, mL | 1.2 | 1.5 | 2 | 2.1 | 2.2 |
| filtrate, oil volume, mL | 1.2 | 1.5 | 2 | 2.1 | 2.2 |
| filtrate, water volume, mL | 0 | 0 | 0 | 0 | 0 |
| filtrate, emulsion volume, mL | 0 | 0 | 0 | 0 | 0 |

Shear Stability test - Polyalpha Olefin

| Base oil | PAO | PAO | Paraffin | Paraffin |
|---|---|---|---|---|
| Volume, mL | 160 | 160 | 160 | 160 |
| Emulsifier, Witcomul 3241, grams | 2 | | 2 | |
| Emulsifier, Emulsifier B, grams | | 2 | | 2 |
| Calcium chloride, 33% solution | 43 | 43 | 43 | 43 |
| Organophilic clay, grams | 3 | 3 | 3 | 3 |
| Barite, grams | 327 | 327 | 327 | 327 |
| Measure sample temperature, ° F. | 119 | 120 | 102 | 99 |
| Measure sample ES, V | 774 | 626 | 1103 | 724 |
| Measure sample temperature, ° F. | 129 | 117 | 119 | 115 |
| Measure sample ES, V | 868 | 840 | 1270 | 885 |

Shear Stability - Normal Paraffin

| Base oil normal paraffin, mL | 160 | 160 | 160 | 160 |
|---|---|---|---|---|
| Emulsifier, Witcomul 3241, grams | 2 | | | |
| Emulsifier, Emulsifier A, grams | | 3 | | |
| Emulsifier, oxidized tall oil, g | | 0.5 | | |
| Emulsifier, Emulsifier B, grams | | | 2 | |
| Emulsifier, Emulsifier C, grams | | | | 2 |
| Calcium chloride, 33% solution | 43 | 43 | 43 | 43 |
| Organophilic clay, grams | 3 | 3 | 3 | 3 |
| Barite, grams | 400 | 400 | 400 | 400 |
| Measure sample temperature, ° F. | 111 | 115 | 99 | 97 |
| Measure sample ES, V | 1103 | 700 | 616 | 415 |
| Measure sample temperature, ° F. | 119 | 120 | 106 | 103 |
| Measure sample ES, V | 1270 | 750 | 960 | 600 |

The emulsifier usage is the minimum amount that can pass the shear stability test.

Mud test - Polyalpha Olefin (PAO)

| | | | | | |
|---|---|---|---|---|---|
| Base oil PAO, mL | 173 | 173 | 173 | 173 | 173 |
| Fresh water, mL | 77 | 77 | 77 | 77 | 77 |
| Organophilic clay, grams | 2 | 2 | 2 | 2 | 2 |
| Emulsifier, Sample A, grams | 8 | 6 | 5 | 4 | 3 |
| Lime, grams | 2 | 2 | 2 | 2 | 2 |
| Organophilic lignite, grams | 7 | 7 | 7 | 7 | 7 |
| Barite, grams | 327 | 327 | 327 | 327 | 327 |
| Calcium chloride, grams | 27 | 27 | 27 | 27 | 27 |
| Test temperature, ° F. | 120 | 120 | 120 | 120 | 120 |
| 600 rpm | 120 | 154 | 134 | 132 | 125 |
| 300 rpm | 82 | 112 | 97 | 97 | 92 |
| 200 rpm | 67 | 94 | 81 | 82 | 78 |
| 100 rpm | 50 | 70 | 62 | 63 | 60 |
| 5 rpm | 20 | 32 | 29 | 30 | 30 |
| 3 rpm | 17 | 28 | 26 | 28 | 29 |
| Electrical stability, V | 1869 | 1074 | 1045 | 872 | 726 |
| Plastic viscosity, cp | 38 | 42 | 37 | 35 | 33 |
| Yield point, lb/100 sq. feet | 44 | 70 | 60 | 62 | 59 |
| 10 sec/10 min. gel, lb/100 sq. feet | 17/22 | 26/32 | 25/34 | 27/34 | 28/36 |
| After rolling 16 hours at 150° F. | | | | | |
| Test temperature, ° F. | 120 | 120 | 120 | 120 | 120 |
| 600 rpm | 111 | 147 | 115 | 107 | 100 |
| 300 rpm | 75 | 103 | 77 | 71 | 67 |
| 200 rpm | 61 | 85 | 64 | 58 | 53 |
| 100 rpm | 44 | 63 | 47 | 42 | 40 |
| 6 rpm | 20 | 30 | 24 | 20 | 20 |
| 3 rpm | 18 | 28 | 22 | 19 | 18 |
| Electrical stability, V | 1769 | 1710 | 1457 | 1158 | 811 |
| Plastic viscosity, cp | 36 | 44 | 38 | 36 | 33 |
| Yield point, lb/100 sq feet | 39 | 59 | 39 | 35 | 34 |
| 10 sec/10 min. gel, lb/100 sq feet | 22/28 | 32/40 | 25/30 | 23/29 | 21/28 |
| HTHP filtrate temperature, 300° F. | | | | | |
| filtrate, total volume, mL | 1 | 1.5 | 2 | 2 | 2.4 |
| filtrate, oil volume, mL | 1 | 1.5 | 2 | 2 | 2.4 |
| filtrate, water volume, mL | 0 | 0 | 0 | 0 | 0 |
| filtrate, emulsion volume, mL | 0 | 0 | 0 | 0 | 0 |

As shown in the above tables, the oil-based drilling fluids mase with current emulsifiers have an extremely high stability and low HTHP (high temperature high pressure) filtration.

In view of the many changes and modifications that can be made without departing from principles underlying the invention, reference should be made to the appended claims for an understanding of the scope of the protection to be afforded the invention.

What is claimed is:

1. A composition comprising a water-in-oil emulsion fluid for use in the drilling, completion or workover of a subterranean well, said emulsion fluid comprising:
A) a base comprising at least one liquid hydrocarbon;
B) an aqueous phase; and
C) an emulsifier comprising at least one amide prepared by reacting at least one fatty amine with at least one polycarboxylic acid.

2. The composition of claim 1 wherein the liquid hydrocarbon base is selected from the group consisting of vegetable oil, mineral oil, synthetic hydrocarbon oil, and diesel oil.

3. The composition of claim 2 wherein the liquid hydrocarbon base is a synthetic hydrocarbon oil.

4. The composition of claim 3 wherein the synthetic hydrocarbon oil is a polyalphaolefin.

5. The composition of claim 1 wherein at least one fatty amine is of the structural formula 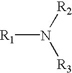
wherein R₁, R₂, and R₃ are selected from the group consisting of hydrogen, hydrocarbyl groups, and hydrocarbyl groups substituted with functional groups, provided that at least one of R₁, R₂, or R₃ is a C₈ or greater hydrocarbyl group.

6. The composition of claim 5 wherein said fatty amine is selected from the group consisting of oleylamine, 1-dodecylamine, di-n-octadecylamine, tri(isodecyl)amine, dimethyl-n-decylamine, bis(2-hydroxyethyl)dodecylamine, tallow amine, bis(2-hydroxyethyl)tallowamine, and bis(2-hydroxypropyl)dodecylamine.

7. The composition of claim 6 wherein said fatty amine is a tallow amine.

8. The composition of claim 1 wherein the polycarboxylic acid is selected from the group consisting of lactic acid, glycollic acid and ether derivatives thereof, succinic acid, malonic acid, (ethylenedioxy) diacetic acid, maleic acid, diglycollic acid, tartaric acid, tartronic acid, fumaric acid, citric acid, aconitic acid, citraconic acid, carboxymethyloxysuccinic acid, lactoxysuccinic acid, 2-oxy-1,1,3-propane tricarboxylic acid, oxydisuccinic acid, 1,1,2,2-ethane tetracarboxylic acid, 1,1,3,3-propane tetracarboxylic acid, 1,1,2,3-propane tetracarboxylic acid, cyclopentane-cis, cis, cis-tetracarboxylic acid, cyclopentadienide pentacarboxylic acid, 2,3,4,5-tetrahydrofuran-cis, cis, cis-tetracarboxylic acid, 2,5-tetrahydrofuran-cis-dicarboxylic acid, 1,2,3,4,5,6-hexane-hexacarboxylic acid, mellitic acid, pyromellitic acid, and phthalic acid.

9. The composition of claim 1 wherein the polycarboxylic acid is a dicarboxylic acid or a tricarboxylic acid.

10. The composition of claim 9 wherein the polycarboxylic acid is a tricarboxylic acid.

11. The composition of claim 10 wherein the tricarboxylic acid is citric acid.
